(19) United States
(12) Patent Application Publication
(10) Pub. No.: US 2002/0150262 A1
(43) Pub. Date: Oct. 17, 2002

(54) Method and apparatus for communicating to vehicle occupants

(76) Inventor: Jerome D. Carter, Queen Creek, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 09/822,994

(22) Filed: Mar. 29, 2001

(51) Int. Cl. H04B 1/00

(52) U.S. Cl. 381/86

(57) ABSTRACT

Briefly, in accordance with one embodiment of the invention, a system includes a detection mechanism that may inform the driver or occupant of a vehicle of the occurrence of a particular sound outside or external to the vehicle.

### BACKGROUND

The development of portable devices such as, cell phones, personal digital assistants, laptop computers, televisions, game consoles, VCR's, etc. has allowed the driver and occupants of vehicles to conduct many tasks while driving or traveling in an automobile. Unfortunately, these devices may also be a source of distraction of the driver of the vehicle.

Likewise, improvements in the design and manufacture of automobiles have been effective in reducing the amount of external sound that may be heard inside the vehicle (e.g. noise cancellation, sound dampening material, etc.). Although this may make the inside of a vehicle quiet, it may make it more difficult to hear important noises outside of a vehicle (e.g. an emergency vehicle, tire screeching, etc). This may be further compounded by the noise and distractions associated with portable devices or music from the sound system in the vehicle. Consequently, the occupants (including the drier) of a vehicle may not be able to hear important sounds.

Thus, a need exists to reduce the risk that the driver or occupant of a vehicle is distracted or unable to hear the appropriate sounds outside the vehicle.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic representation of a system that may be used to notify the occupant of a vehicle of the occurrence of a particular sound in accordance with an embodiment of the present invention; and

FIG. 2 is a flow chart of a method in accordance with an embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computing device selectively activated or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

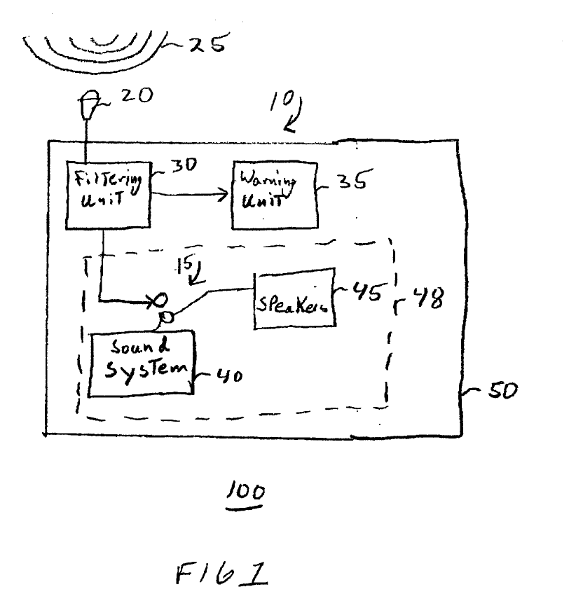

Turning to FIG. 1, an embodiment 100 in accordance with the present invention is described. Embodiment 100 may comprise a sound detection system 10 that may be used to notify the occupants of a vehicle 50 of the occurrence of a detected sound that is external to vehicle 50. For example, system 10 may be used to notify the driver of vehicle 50 of the detection of sound associated with an emergency vehicle (i.e. the siren of an ambulance, fire truck, etc), although the scope of the present invention is not limited in this respect.

System 10 may comprise a microphone 20 that may be used to detect or capture at least a portion of the sound occurring outside or external (sound 25) to vehicle 50. Although the scope of the present invention is not limited in this respect, microphone 20 may comprise two or more microphones that are mounted at various locations of vehicle 50 and the microphones may be adapted to sense or capture different sounds (i.e. the microphones may be adapted to sense sounds of different frequency ranges, amplitude, magnitude, etc.). Thus, the microphones may be mounted so as to effectively detect different sounds that may originate from different locations relative to vehicle 50. It should also be understood that microphone 20 may have an adjustable threshold setting or may be selected for having sensitivity to sound having certain characteristics (i.e. frequency, etc.).

At least a portion of the sound from microphone 20 may be filtered by a filtering unit 30 to select the portion of the external sound that is of the most interest to the occupant(s) of vehicle 50. Although the scope of the present invention is not limited in this respect, filter unit 30 may comprise one or more band-pass filters that may be used to select the portion of the external sound that is within particular frequency range(s). The frequency range or filtering scheme may be tailored so that particular sounds may be detected. For example, filtering unit may be used to select the portion of the external sound associated with the sound coming from the siren of an emergency vehicle.

In alternative embodiments, filtering unit 30 may include a processing unit that may comprise circuitry to convert all or part of the external sound to a digital representation. For example, analog-to-digital converters may be used to convert all or part of the signal from microphone 20 to a digital signal. Although the scope of the present invention is not limited in this respect, the digital signal may then be further filtered or analyzed to determine if the external sound has particular characteristics (i.e. the external sound comprises sound with a particular frequency, amplitude, or magnitude).

For example, the digital signal may be processed with a digital signal processor (DSP) to detect the presence of some particular characteristics in the external sound that may be from a particular source (i.e. the siren of an emergency vehicle). A DSP may also be well suited to comparing the detected sound to stored samples so that it may actually determine or predict the type of sound that was captured by microphone 20 and its origin. However, it should be understood that the processing unit may alternatively comprise a microprocessor, a microcontroller, or other central processing unit (CPU) that may be used to analyze the external sound with some combination of hardware and software. As sound is an analog signal, filtering unit 30 may also be able to adjust the threshold level at which system 10 may notify the driver/occupant of the occurrence of the detected sound. Although the scope of the present invention, system 10 may be programmable such that system 10 the threshold value may be adjusted to reduce the risk of false detection or notification of particular sounds.

System 10 may also comprise a warning unit 35 that may be used to notify the driver or occupant of the occurrence of the detected sound. For example, warning unit may comprise a warning light indicator that is enabled when a particular sound is detected. Alternatively, warning unit 35 may comprise as transmitter that may be used to transmit a pre-recorded message if a particular sound is detected external to the vehicle.

In alternative embodiments, system 10 may use speakers 45 to broadcast the external sound, or otherwise notify the driver/occupants of the detected sound. For example, system 10 may use the speakers of an existing sound system 40 (i.e. radio, headphones, PDA, cell phone, etc.). Thus, the combination of speakers 45 and at least a portion of sound system 40 may act as a broadcast unit 48 that may be used to transmit or broadcast at least a portion of the detected sound (i.e. sound 25) in vehicle 50. In yet other alternative embodiments, system 10 may simply disable or mute speakers 45, as a form of notification of the occurrence of detected sound (i.e. sound 25) so that the driver/occupant of vehicle may better hear external sound 25.

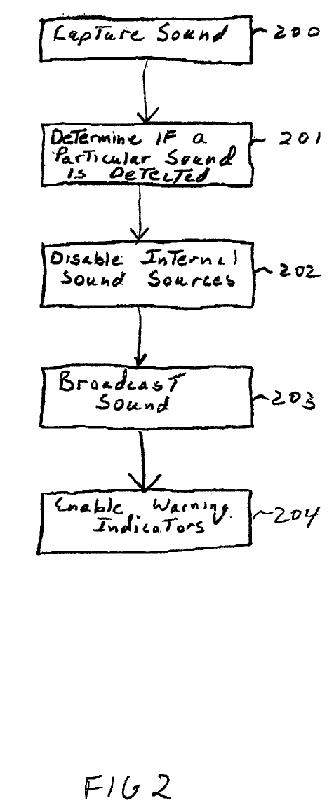

Turning now to FIG. 2, a method in accordance with an embodiment of the present invention is provided. Although the scope of the present invention is not limited to this particular example, the method may begin by capturing at least a portion of the sound that is occurring external to a vehicle, step 200. It should be understood that the signal that is captured is not limited to audible noise. In alternative embodiments, the signals associated with other sources such as infra-red, ultraviolet, etc may also be captured. Thus, alternative embodiments of the present invention may be used to notify the driver or occupant of more than just the occurrence of an emergency vehicle siren or screeching tire. In some embodiments, the system may be able to notify the driver/occupant of the detection of signals such as a cell phone communication, signals from a security system, signals from a garage door opener, signals from an automatic toll booth, etc.

After the sound signal is captured, it may be filtered or otherwise processed to determine if the captured sound includes sounds or signals have particular characteristics (i.e. characteristics suggesting the origin or nature of the sound such as a siren, security transmission, etc.), step 201. As described earlier with reference to FIG. 1, the sound may be filtered and processed with a variety of combinations of hardware and software that may determine if the captured sound comprises sounds or signals that the driver/occupants should be made aware of.

If sound having particular characteristics is detected, the system may optionally disable internal sources of sound or other distraction, step 202. For example, the sound system may be disabled, cell phone communications may be disabled, or televisions/VCR's may be muted or paused. This alone may be sufficient to notify the driver/occupant of the occurrence of the detected sound. By disabling internal sound sources, the driver/occupant may be better suited to hear the external sound that was detected. Thus, notifying or informing the occupant of a vehicle of the occurrence of a detected sound may include altering the environment within the vehicle (i.e. disabling a sound system, etc.) so that the occupant(s) may hear the sound. Likewise, by removing other sources of distraction, such as a cell phone and the like, the driver/occupant may have a greater attention span to react to the sound detected.

The system may also optionally broadcast or transmit at least a portion of the detected sound in the vehicle, step 203. For example, the system may use the speakers of an existing sound system or its own speakers to recreate/broadcast the sound that was detected. This may be desirable for drivers/occupants that might otherwise have difficulty hearing (i.e. hearing impaired). Additionally or alternatively, the detected sound may be broadcasted through headphones worn by the occupants or through the speaker of a cell phone if the cell phone is in use at the time.

Optionally, the system may also enable other warning indicators in order to notify or inform the driver or occupants of the occurrence of the detected sound, step 204. Although the scope of the present invention is not limited in this respect, the system may enable visual indicators such a lights within the occupants view or on a heads-up display. Accordingly, some embodiments of the present invention may be able to alter the environment within a vehicle so that the driver or occupants of the vehicle may be informed of and respond to sound occurring outside the vehicle. This, in turn, may improve the safety of the driver or occupants of a vehicle.

While certain features of the invention have been illustrated and described herein, many modifications, substitutions, changes, and equivalents will now occur to those skilled in the art. For example, the scope of the present invention is not limited to vehicles. Embodiments of the present invention may have application to other situations where a person is somehow isolated from a sound (e.g., a phone booth, airplane, etc.) It is, therefore, to be understood that the appended claims are intended to cover all such modifications and changes as fall within the true spirit of the invention.

1. A method comprising:
notifying an occupant of a vehicle of the occurrence of a detected sound outside of the vehicle.

2. The method of claim 1, further comprising notifying the occupant of the vehicle that sound associated with an emergency vehicle has been detected.

3. The method of claim 2, wherein the notifying the occupant includes broadcasting at least a portion of the sound associated with the emergency vehicle through at least a portion of a sound system in the vehicle.

4. The method of claim 3, wherein broadcasting at least a portion of the sound associated with the emergency vehicle includes broadcasting the sound through headphones.

5. The method of claim 2, further comprising disabling a sound system in the vehicle, so that the detected sound may be heard in the vehicle.

6. The method of claim 2, further comprising disabling a portable communication device in the vehicle.

7. The method of claim 1, further comprising detecting sound associated with an emergency vehicle to provide the detected sound.

8. The method of claim 7, wherein detecting sound includes filtering sound outside the vehicle such that sound having a desired frequency range is heard in the vehicle.

9. The method of claim 8, wherein filtering sound includes processing the sound with a processing unit.

10. The method of claim 9, wherein processing the sound includes converting the sound to a digital representation.

11. The method of claim 1, wherein notifying the occupant includes broadcasting a prerecorded message.

12. The method of claim 1, wherein notifying the occupant includes enabling a warning indicator.

13. A method comprising:
detecting the occurrence of a particular sound outside of a vehicle; and
informing an occupant of the vehicle of the occurrence of the particular sound.

14. The method of claim 13, wherein detecting the occurrence of a particular sound includes:
capturing sound external to the vehicle with a microphone; and
determining if at least a portion of the sound external to the vehicle comprises a predetermined characteristic.

15. The method of claim 14, wherein determining if at least a portion of the sound external to the vehicle comprises a predetermined characteristic includes filtering the sound external to the vehicle.

16. The method of claim 14, wherein determining if at least a portion of the sound external to the vehicle comprises a predetermined characteristic includes converting at least a portion of the sound external to the vehicle to a digital representation and determining if the digital representation includes the predetermined characteristic.

17. The method of claim 13, wherein informing an occupant of the vehicle of the occurrence of the particular sound includes broadcasting at least a portion of the particular sound in the vehicle.
